(19) United States
(12) Patent Application Publication
(10) Pub. No.: US 2003/0041260 A1
(43) Pub. Date: Feb. 27, 2003

(54) Security protection system for identifying a user who uses an electronic device

(75) Inventor: Yoshihito Yoneyama, Gunma (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/222,854

(22) Filed: Aug. 19, 2002

(30) Foreign Application Priority Data
Aug. 27, 2001 (JP) 2001-255856

(51) Int. Cl. H04L 9/00

(52) U.S. Cl. 713/200

(57) ABSTRACT

The present invention provides a security protection system that protects security of an electronic device, wherein the system includes a security protection device sending a permission-to-use or limitation-on-use notification to an electronic device to be security protected and wherein, if the permission-to-use notification is not received from the security protection device, a start control function is provided in the electronic device for executing processing under control of BIOS to prevent the electronic device from being started.

### BACKGROUND OF THE INVENTION

1. Field of the Invention

The present invention relates to a security protection system, a security protection device, a security protection method, and a recording medium recoding therein a security protection program for identifying a user who is going to use an electronic device such as a computer. More particularly, the present invention relates to a security protection system that controls the start of an electronic device via BIOS (Basic Input/Output System).

2. Description of the Prior Art

A conventional security protection system for an electronic device such as a computer is, for example, a technology disclosed in Japanese Patent Laid-Open Application No. 2001-27911. This technology introduces an unauthorized-access prevention system that starts the OS (Operating System) only when a password entered by the user after a personal computer is turned on is correct. This system prevents an unauthorized user from copying, rewriting, or deleting files stored on a hard disk. The reason is that, unless the OS is started, the files stored on a hard disk cannot be accessed.

However, the procedure of the conventional security system makes the user feel cumbersome because, after power is turned on, the user must enter a password for identification.

Another problem is that the conventional security protection system requires one system for each personal computer. This means that, in situation where a plurality of personal computers are installed, installing the security protection system on all personal computers increases the installation cost.

### SUMMARY OF THE INVENTION

To solve the problems with the conventional system described above, it is a first object of the present invention to provide a security protection system and so on that allow a security system to be built at lower cost by executing the start control of an electronic device, such as a computer, under program control via BIOS.

To solve the problems with the conventional system described above, it is a second object of the present invention to provide a security protection system and so on that integrally manage the identification of a plurality of electronic devices via a network.

A security protection system according to the present invention that protects security of an electronic device comprises a security protection device sending a permission-to-use or limitation-on-use notification to the electronic device to be security protected, wherein, if the permission-to-use notification is not received from the security protection device, a pre-set start control function limiting a use of the electronic device is set in the electronic device.

A security protection device according to the present invention that protects security of an electronic device sends a permission-to-use notification to the electronic device to be security protected if the user is identified correctly when a notification notifying that a user will start using the electronic device is received from a user identification device, and sends a limitation-on-use notification to the electronic device to be security protected if the user is identified correctly when a notification notifying that the user has finished using the electronic device is received from the user identification device.

A security protection method according to the present invention for protecting security of an electronic device comprises the step of receiving, by the electronic device to be security protected, a permission-to-use or limitation-on-use notification from a security protection device that manages security, and, if the permission-to-use notification is not received, executing pre-set processing to limit a use of the electronic device under control of BIOS.

A recording medium according to the present invention recording therein a security protection program protecting security of an electronic device to be security protected, wherein the security protection program controls a computer to send a permission-to-use notification to the electronic device to be security protected if a user is identified correctly when a notification notifying that the user will start using the electronic device is received from a user identification device and to send a limitation-on-use notification to the electronic device to be security protected if the user is identified correctly when a notification notifying that the user has finished using the electronic device is received from the user identification device.

### BRIEF DESCRIPTION OF THE DRAWINGS

FIG. 1 is a block diagram showing the configuration of a security protection system;

FIG. 2 is a flowchart showing the operation when a user starts using a personal computer;

FIG. 3 is a flowchart showing the BIOS operation when a personal computer is started;

FIG. 4 is a flowchart showing the operation when a user ends using a personal computer; and

FIG. 5 is a flowchart showing the BIOS operation when a personal computer is ended.

### DETAILED DESCRIPTION OF THE PREFERRED EMBODIMENTS

Some embodiments of the present invention will be described in detail by referring to the attached drawings.

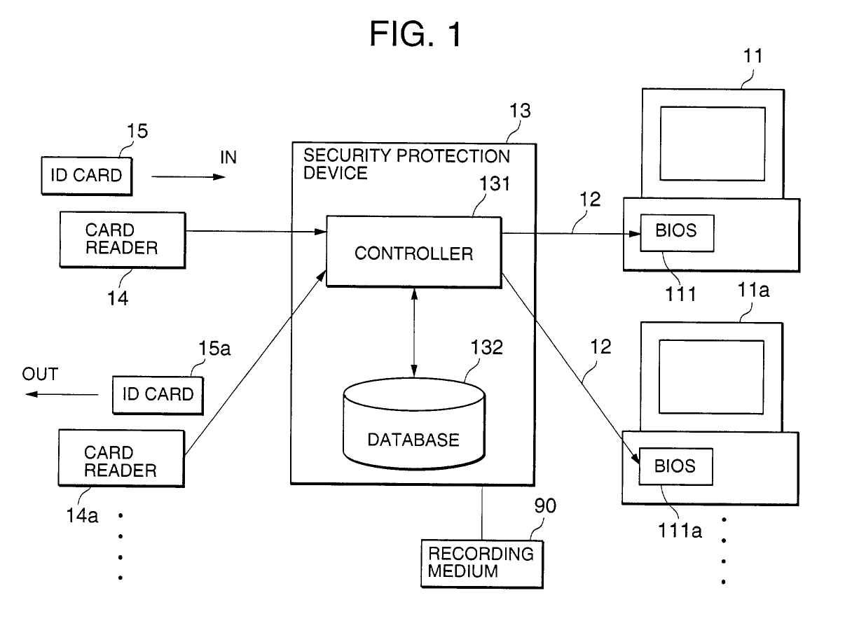

FIG. 1 is a block diagram showing the configuration of a security protection system in a first embodiment according to the present invention. Referring to FIG. 1, the security protection system in this embodiment, which comprises a personal computer 11, a network 12, a security protection device 13, and a card reader 14, performs user identification using an ID card 15.

In the embodiment shown in FIG. 1, where the personal computer 11 is a computer to be security protected, whether to permit the start of this personal computer is controlled such that, if the user is not identified successfully, the personal computer 11 is not started. It should be noted that a computer that is an electronic device to be controlled is not limited to the personal computer 11 but that other types of computer or other information devices (for example, a copier or printer) may also be controlled in the same way.

Although the user identification method in the embodiment shown in FIG. 1 uses the ID card 15 to identify the user, the user identification method is not limited to the ID card 15 but other means such as a password, a fingerprint, the iris of an eye, or a voiceprint may also be used as long as it identifies individuals.

In the security protection system in this embodiment, the security protection device 13 notifies the user's personal computer 11 whether the user is permitted to start the personal computer, based on the user identification result produced by the card reader 14. In this way, the system controls whether or not the user is permitted to start the personal computer 11 based on the identification result and, if the user is not notified of permission, the system prevents the personal computer 11 from being started to protect security. The start control of the personal computer 11 based on the identification result is executed by including the start control program into the BIOS 111 of the personal computer 11.

Although, in this embodiment, start control processing is executed by the BIOS of a personal computer, the same start control may also be implemented by separately including a start control hardware unit or a start control software program that executes the same start control.

The personal computer 11 receives a permission signal 21, which indicates the permission of start, or an inhibition signal 22, which indicates the inhibition of start, from the security protection device 13 via the built-in BIOS 111 and retains those signals. When the user turns on the personal computer 11, the BIOS 111 starts the personal computer only when the permission signal 21 is retained. On the other hand, when the inhibition signal 22 is retained, the BIOS 111 displays a warning message on the monitor of the personal computer 11 and then turns off the personal computer 11. If the inhibition signal 22 is sent from the security protection device 13 during the startup of the personal computer 11, the BIOS 111 displays a warning message on the monitor of the personal computer 11 and then forces the personal computer 11 to be turned off.

The network 12 connects the personal computer 11 to the security protection device 13 over a communication line to send the permission signal 21 or the inhibition signal 22 from the security protection device 13 to the personal computer 11. The network 12 may be, for example, a LAN or other networks.

The security protection device 13 comprises a controller 131 that processes information sent from the card reader 14 and a database 132 (service management database and so on) in which the information is stored.

When the controller 131 receives information from the card reader 14, which is an identification unit identifying the user, and recognizes that the user has entered the operation environment of the personal computer 11, the controller 131 stores entry information into the database 132 and, at the same time, sends the permission signal 21, which is a signal permitting the use of the personal computer 11, to the personal computer 11 over the network 12.

Alternatively, when the controller 131 receives information from the card reader 14 and recognizes that the user has left the operation environment of the personal computer 11, the controller 131 stores exit information into the database 132 and, at the same time, sends the inhibition signal 22, which is a signal inhibiting the use of the personal computer 11, to the personal computer 11 over the network 12.

When the controller 131 is connected to a plurality of personal computers 11 as shown in FIG. 1, information on users of each personal computer 11 is recorded in the database 132 for later reference. Whether to permit the start of each personal computer 11 is controlled, and security is protected, by referencing this information.

The card reader 14 sends information, read from the ID card 15, to the security protection device 13.

Next, the operation of the security protection system in this embodiment will be described in detail with reference to the drawings.

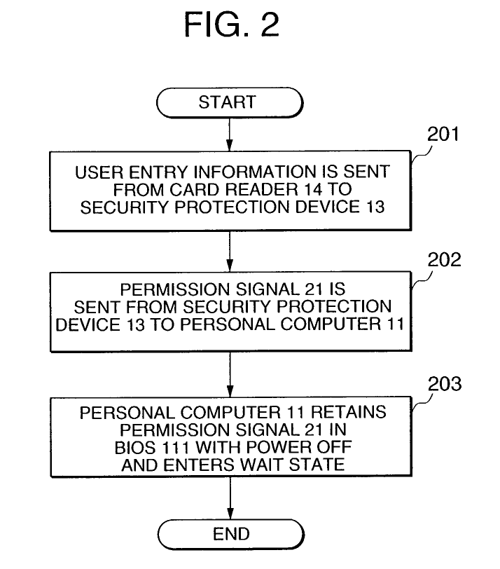

First, the operation of the security protection system in this embodiment that is executed when the user has entered the operation environment of the personal computer 11 will be described. FIG. 2 is a flowchart showing the operation of the security protection system in this embodiment that is executed when the user has entered the operation environment of the personal computer 11.

First, when the user enters the ID card 15 into the card reader 14 to record that the user has entered the operation environment of the personal computer 11, entry information is sent from the card reader 14 to the security protection device 13 (step 201).

The security protection device 13 that receives the information from the card reader 14 stores the received information into the database 132 under control of the controller 131. At the same time, the security protection device 13 sends the permission signal 21 to the personal computer 11 of the user over the network 12 to permit the user to use the computer (step 202).

Upon receiving the permission signal 21 from the security protection device 13, the personal computer 11 retains the permission signal 21 in the BIOS 111 with the power off and waits for the user to turn on the power (step 203).

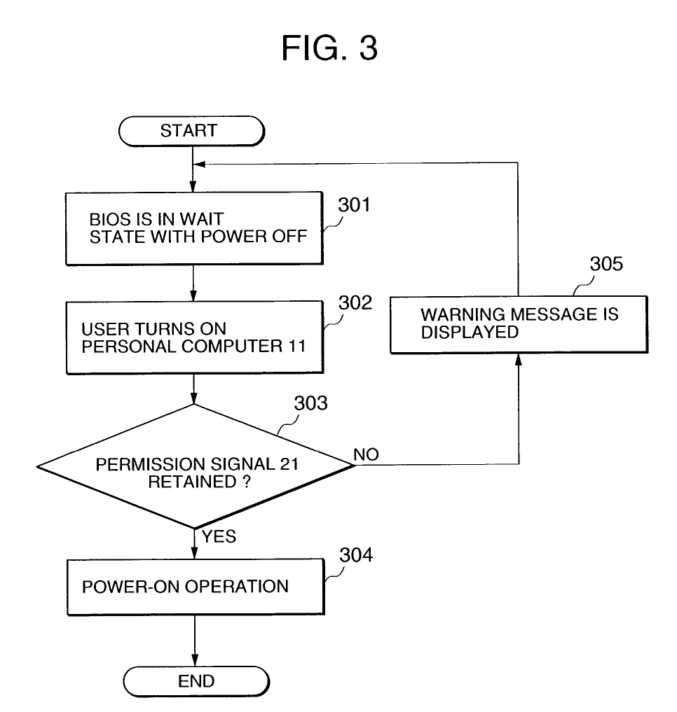

Now, the operation of the BIOS 111 that is executed when the personal computer 11 is started will be described. FIG. 3 is a flowchart showing the operation of the BIOS 111 that is executed when the personal computer 11 is started.

When the user turns on the personal computer 11, the BIOS 111 that is in the wait state with the power off references the retained signal (steps 301, 302, 303). If the retained signal is the permission signal 21, the BIOS 111 starts the usual power-on operation; if the retained signal is the inhibition signal, the BIOS 111 displays a warning message on the monitor of the personal computer 11 (steps 304 and 305) and turns off the power.

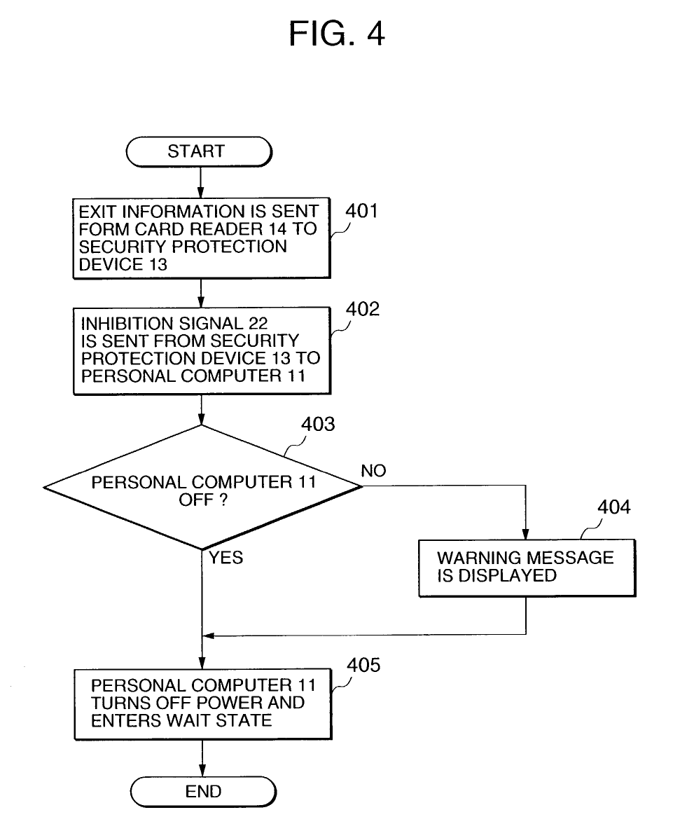

Next, the operation of the security protection system in this embodiment that is executed when the user has left the operation environment of the personal computer 11 will be described. FIG. 4 is a flowchart showing the operation of the security protection system in this embodiment that is executed when the user has left the operation environment of the personal computer 11.

In FIG. 4, when the user enters the ID card 15 into the card reader 14 to record that the user has left the operation environment of the personal computer 11, exit information is sent from the card reader 14 to the security protection device 13 (step 401).

Upon receiving the information from the card reader 14, the security protection device 13 stores the received information into the database 132 under control of the controller 131. At the same time, the security protection device 13 sends the inhibition signal 22, which inhibits the personal computer 11 from being used, to the personal computer 11 over the network 12 (step 402).

The personal computer 11, which has received the inhibition signal 22, checks that the power is off. If the power is not off, the personal computer 11 displays a warning message on its monitor, turns off the power, and enters the wait state (steps 403, 404, 405).

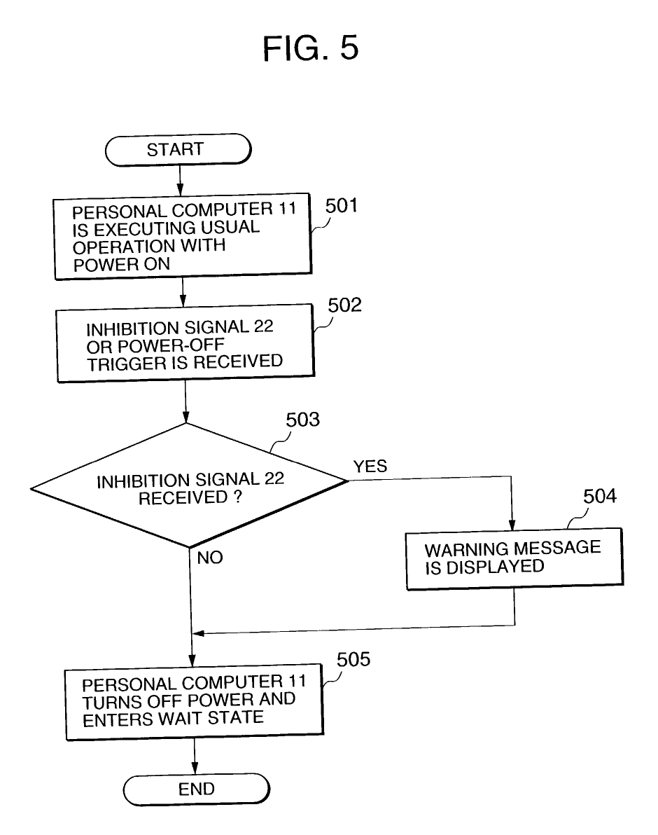

Next, the operation of the BIOS 111 that is executed when the personal computer 11 ends processing will be described. FIG. 5 is a flowchart showing the operation of the BIOS 111 that is executed when the personal computer 11 ends processing.

When the BIOS 111 receives the inhibition signal 22 from the security protection device 13 while the personal computer 11 is executing a usual operation with the power on or receives the power-off trigger generated by the user who turned off the power, the BIOS 111 checks if the received signal was the inhibition signal (steps 501, 502, 503). If the received signal was the inhibition signal, the BIOS 111 displays a warning message on the monitor of the personal computer 11 and starts end processing; if the received signal was not the inhibition signal, the BIOS 111 starts usual end processing, turns off the power, and enters the wait state (steps 504 and 505).

The security protection system in this embodiment may be implemented, for example, by installing a user identification device, such as the card reader 14, at the entry of a room where personal computers are installed or at the entry of a building so that the user may perform the identification procedure using the ID card 15 when he or she enters or leaves the room or the building. Based on the user identification result, the security protection device 13 notifies the user's personal computer 11 in the room over the network 12 whether or not the user is permitted to start the personal computer 11. The user's personal computer 11 is started under control of the BIOS 111 only when the start permission notification is received from the security protection device 13 and, therefore, security is protected.

As described above, the security protection system in this embodiment integrally manages the security of a plurality of computers over a network and starts a computer under program control, that is, under BIOS control, thus making it possible to build a low-cost security protection system.

Next, other embodiments of the present invention will be described.

In the first embodiment, the security protection device 13 sends the start permission notification (permission signal 21, inhibition signal 22) to the personal computer 11 when the card reader 14 identifies the user. However, the present invention is not limited to this method. For example, when the start operation is executed on the personal computer 11, the personal computer 11 may access the security protection device 13 over the network 12 under control of the BIOS 111 to make a request for, and receive, the start permission notification (permission signal 21, inhibition signal 22) at that moment. In addition to the effect of the first embodiment, this embodiment has another effect that the personal computer 11 need not have the BIOS 111 constantly in operation.

In addition, the present invention provides, as a security management level, not only the computer start permission control method but also another security management method. That is, the permission signal 21 or the inhibition signal 22 sent from the security protection device 13 to the personal computer 11 may be used not only for controlling the start of the personal computer 11 as described in the first embodiment but for another type of security management. For example, security protection may be implemented also by unconditionally starting the personal computer 11 for use by the user only when the permission signal 21 is sent to the personal computer 11 and, in other cases, by requesting the user to enter a password for identification at a start time.

The control described above may be implemented via the BIOS 111 contained in the personal computer 11 as in the first embodiment, that is, the control may be implemented simply by changing the system of the BIOS 111 with no need to add special hardware. This makes security levels more flexible. More specifically, the security protection device 13 issues the signal notifying permission to use, or limitation on the use of, the personal computer 11 to the personal computer 11. If the permission signal is not issued, predetermined use-limiting processing (password entry or start operation suspension) is executed.

In the first embodiment, a plurality of personal computers 11 are connected to the security protection device 13 for managing the security of each personal computer 11. It should be noted that the security protection device 13 may be connected to any number of personal computers 11 or to only one personal computer 11 for managing security. When only one personal computer 11 is managed, the personal computer 11 need not be connected to the security protection device 13 via the network 12 such as a LAN but, instead, the personal computer 11 may also be connected directly to the security protection device 13.

In the first embodiment, the user uses the ID card 15 to perform the identification operation and, based on the operation, the system controls whether or not the user is permitted to start the personal computer. In addition to this method, data about user's working hours or about the time zones in which the user is permitted to use the personal computer 11 may be stored in the database in the security protection device 13 to allow the security protection device 13 to control whether to permit the start of the personal computer 11 according to the pre-set times. This method eliminates the need for the user to perform the identification operation but allows the user to use the personal computer 11 during pre-set times.

In the first embodiment, the BIOS 111 executes the control operation to determine whether the user is permitted to start the personal computer 11. Instead of this method, a software program, which is executed after the start of the personal computer 11, may execute a part of the control operation of the present invention in the personal computer 11. For example, the software program may execute the power-off operation while the personal computer is in operation (step 405) or may check if the BIOS 111 is rewritten during the startup of the personal computer 11.

The function of the controller 131 in the security protection device 13 or other functions of the security protection system in this embodiment may be implemented not only by hardware devices but also by loading a security protection program, a computer program having those functions; into the memory of the computer processor. This security protection program is stored on a magnetic disk, in a semiconductor memory, or on other recording medium 90. The program is loaded into the computer processor from the recording medium for controlling the operation of the computer processor to execute the functions described above.

Although the present invention has been described above in connection with various preferred embodiments thereof, it is to be understood that the present invention is not limited to the embodiments described above but that the present invention may be implemented in various ways within the scope of the technological concept.

The present invention described above has the following effects.

First, the system according to the present invention can manage computer security and protect data from being stolen. This is because, even if an attempt is made to start a computer at a location where the computer is not to be used, that is, at a location not connected to the originally intended network, the computer cannot be started.

Second, the system according to the present invention can manage the start of a computer via BIOS that is one of software components, thus eliminating the need for providing special hardware in the personal computers to be managed and reducing the security system construction cost.

Third, the system according to the present invention uses a database to automatically store or delete security information. This eliminates cumbersome operations that the user must execute to store or delete information into or from the security system.

Fourth, the system according to the present invention securely turns off the computer power. This is because the personal computer power is automatically turned off as the user leaves the room or because the power is automatically turned off via a database in which user's working hours and other information are stored.

What is claimed is:

1. A security protection system that protects security of an electronic device, said system comprising a security protection device sending a permission-to-use or limitation-on-use notification to the electronic device to be security protected,
wherein, if the permission-to-use notification is not received from said security protection device, a pre-set start control function limiting a use of the electronic device is set in the electronic device.

2. The security protection system according to claim 1, wherein, if the permission-to-use notification is not received from said security protection device, the electronic device to be security protected executes processing under control of BIOS (Basic Input/Output System) to prevent the electronic device from being started.

3. The security protection system according to claim 1, wherein, if the permission-to-use notification is not received from said security protection device, the electronic device to be security protected executes processing under control of BIOS to request a user to enter a password during startup of the electronic device for identifying the user.

4. The security protection system according to claim 1, 2, or 3, wherein, when a notification notifying that the user will start using the electronic device is received from a user identification device, said security protection device sends the permission-to-use notification to the electronic device to be security protected if the user is identified correctly and wherein, when a notification notifying that the user has finished using the electronic device is received from the user identification device, said security protection device sends the limitation-on-use notification to the electronic device to be security protected if the user is identified correctly.

5. The security protection system according to claim 4, wherein, when the limitation-on-use notification is received from said security protection device while the electronic device is in operation, the electronic device to be security protected performs processing to end processing of the electronic device under control of BIOS.

6. The security protection system according to claim 5, wherein the electronic device to be security checked issues a warning message under control of BIOS before ending processing of the electronic device based on the limitation-on-use notification received from said security protection device.

7. The security protection system according to claim 1, 2, to 3, wherein a plurality of the electronic devices to be security protected are connected to said security protection device over a network and said security protection device comprises a database to notify the electronic device used by the user whether the user is permitted to use the electronic device, said database indicating a correspondence between each user and the electronic device used by the user.

8. A security protection device that protects security of an electronic device,
wherein, when a notification notifying that a user will start using the electronic device is received from a user identification device, said security protection device sends a permission-to-use notification to the electronic device to be security protected if the user is identified correctly, and
wherein, when a notification notifying that the user has finished using the electronic device is received from the user identification device, said security protection device sends a limitation-on-use notification to the electronic device to be security protected if the user is identified correctly.

9. The security protection device according to claim 8, wherein a plurality of the electronic devices to be security protected are connected to said security protection device over a network and said security protection device comprises a database to notify the electronic device used by the user whether the user is permitted to use the electronic device, said database indicating a correspondence between each user and the electronic device used by the user.

10. A security protection method for protecting security of an electronic device, comprising the steps of:
(a) receiving a permission-to-use or limitation-on-use notification from a security protection device that manages security; and
(b) executing pre-set processing to limit a use of the electronic device under control of BIOS if the permission-to-use notification is not received.

11. The security protection method according to claim 10, further comprising the step of:
executing processing under control of BIOS to prevent the electronic device from being started if the permission-to-use notification is not received from said security protection device.

12. The security protection method according to claim 11, further comprising the step of:
executing processing under control of BIOS to request a user to enter a password during startup of the electronic device for identifying the user if the permission-to-use notification is not received from said security protection device.

13. The security protection method according to claim 10, 11, or 12, further comprising the steps of:
when a notification notifying that the user will start using the electronic device is received from a user identification device, sending the permission-to-use notification to the electronic device to be security protected if the user is identified correctly; and
when a notification notifying that the user has finished using the electronic device is received from the user identification device, sending the limitation-on-use notification to the electronic device to be security protected if the user is identified correctly.

14. The security protection method according to claim 13, further comprising the step of performing processing to end processing of the electronic device under control of BIOS when the limitation-on-use notification is received from said security protection device while the electronic device is in operation.

15. The security protection method according to claim 14, further comprising the step of issuing a warning message under control of BIOS before ending processing of the electronic device based on the limitation-on-use notification received from said security protection device.

16. The security protection method according to claim 10, 11, or 12, further comprising the step of connecting to a plurality of the electronic devices to be security protected over a network, and notifying the electronic device, which is used by the user, whether the user is permitted to use the electronic device based on a database indicating a correspondence between each user and the electronic device used by the user.

17. A recording medium recording therein a security protection program protecting security of an electronic device to be security protected, wherein said security protection program controls a computer to:
send a permission-to-use notification to the electronic device to be security protected if a user is identified correctly when a notification notifying that the user will start using the electronic device is received from a user identification device; and
send a limitation-on-use notification to the electronic device to be security protected if the user is identified correctly when a notification notifying that the user has finished using the electronic device is received from the user identification device.

18. The recording medium according to claim 17, wherein said security protection program further controls the computer to:
connect to a plurality of the electronic devices to be security protected over a network and notify the electronic device used by the user whether the user is permitted to use the electronic device based on a database indicating a correspondence between each user and the electronic device used by the user.
